(19) United States
(12) Patent Application Publication
(10) Pub. No.: US 2013/0263198 A1
(43) Pub. Date: Oct. 3, 2013

(54) TWO-WAY ASYMMETRIC INTERNET DATA COMMUNICATION USING A BROADCAST TELEVISION SIGNAL

(71) Applicant: Humberto Garriga, Miami, FL (US)

(72) Inventor: Humberto Garriga, Miami, FL (US)

(21) Appl. No.: 13/436,208

(22) Filed: Mar. 30, 2012

(51) Int. Cl. H04N 21/643

(52) U.S. Cl. 725/110

(57) ABSTRACT

A method, system, and computer program product for bi-directional Internet protocol (IP) data transport through a broadcast TV signal is provided. The method can include establishing a communication path between a customer premise equipment (CPE) device and a router of a headend system, receiving an Internet data request from a computing device of an end user, and communicating the request to the headend system over the communication path, where the communication path can be a separate return path. The method can further include listening for motion picture expert group (MPEG) packets broadcasted from a TV transmission facility in response to the request, extracting IP data packets from the MPEG packets, and returning the extracted IP data packets to the computing device as a response to the Internet data request.

### BACKGROUND OF THE INVENTION

1. Field of the Invention

The present invention relates to telecommunications and, more particularly, to digital data broadcast over a television network.

2. Description of the Related Art

Telecommunications is the transmission of information over a distance in order to communicate. In earlier times, telecommunications involved the use of visual signals; in modern times, telecommunications includes the use of electrical devices, radio and microwave communications, and the global Internet. A broadcast system is a species of a telecommunications system. In a broadcast system, a central high-powered broadcast tower transmits high-frequency electromagnetic waves to numerous low powered receivers, such as television sets. The high-frequency waves transmitted by the tower are modulated with a signal containing visual or audio information. The receiver is then tuned so as to pick up the high-frequency waves, and a demodulator is used to retrieve the signal containing the visual or audio information. The broadcast signal can be either analog (signal is varied continuously with respect to the information) or digital (information is encoded as a set of discrete values).

In June 2009, the United States transitioned to digital television (DTV) from analog broadcasts for high-power over-the-air broadcasts. Traditionally, delivery of video is accomplished by sending a broadcast signal from one antenna attached to a broadcast tower. This signal is sent via one frequency in an omni-directional, over-the-air, three hundred sixty degree radius from the antenna in a given coverage area. DTV signals in the U.S. and Canada conform to the Advanced Television Systems Committee (ATSC) standards for digital television transmission. ATSC uses 8-VSB modulation, which, after modulation and error-correction, supports a digital data stream of about 19.39 Mbit/s.

As another telecommunication system in the form of a data communications network, the global Internet allows a worldwide network of users to communicate with each other via respectively different computing devices. Traditionally, when a user from a corresponding computer navigates to a Web page, a set of protocols can be used to correctly communicate between the computer and device, such as a server, on which the document or service is located. Specifically, when a user seeks to view a Web page, the Hypertext Transfer Protocol (HTTP) can be employed through an appropriately configured Web browser to request and then receive the desired Web page. Of note, HTTP is a specification of a standard for asynchronously requesting and receiving data over the Internet.

Attempts have been made in the past to view broadcast content originally intended for broadcast over the television network within a Web browser over the global Internet. In an “on demand” environment, viewing broadcast television content through a Web browser or a custom client utilizing the global Internet is both popular and desirable. However, in all instances, the broadcast content first is reduced to a standard, streamable format (typically a variant of the motion picture experts group standard, also known as the “MPEG” standard) and then streamed to or downloaded to a client computing device for viewing.

### BRIEF SUMMARY OF THE INVENTION

Embodiments of the present invention address deficiencies of the art in respect to data transport and provide a novel and non-obvious method, system, and computer program product for bi-directional IP data transport through a broadcast television (TV) signal. In an embodiment of the invention, a method for bi-directional IP data transport using a broadcast TV signal is provided and includes establishing a communication path between a customer premise equipment (CPE) device and a router of a headend system, receiving an Internet data request from a computing device of an end user at the CPE device, and communicating the request to the headend system over the communication path, where the communication path can be a separate return path. The method can further include listening for MPEG packets broadcasted from a TV transmission facility through the headend system in response to the request, extracting downstream IP data packets from the MPEG packets, and returning the extracted IP data packets to the computing device as a response to the Internet data request.

Another embodiment of the invention provides for a bi-directional IP data transport system using a broadcast TV signal. The system can include a CPE device that includes each of an embedded computer with at least one processor and memory, a tuner and also an IP data transport module. The IP data transport module can include program code configured upon execution in the computer to establish a communication path between the CPE device and a router of a headend system, to receive an Internet data request from a computing device of an end user at the CPE device, to communicate the request to the headend system over the communication path, to listen for MPEG packets broadcasted from a TV transmission facility through the headend system as a response to the request, to extract IP data packets from the MPEG packets, and to return the IP data packets as a response to the Internet data request to the computing device of the end user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred; it is understood, however, that the invention is not limited to the precise arrangements and instrumentalities shown, wherein:

FIG. 1 is a pictorial illustration of a process for bi-directional IP data transport using a broadcast TV signal to a computing device;

FIG. 2 is a schematic illustration of a data processing system configured for bi-directional IP data transport through a digital television (TV) signal;

FIG. 3A is a flow chart illustrating a process for bi-directional IP data transport using a broadcast TV signal; and,

FIG. 3B is a flow chart depicting a process for receiving IP data.

### DETAILED DESCRIPTION OF THE INVENTION

Embodiments of the invention provide for delivering Internet data to a computing device utilizing a TV broadcast signal. In accordance with an embodiment of the invention, a CPE device, which can include an ATSC tuner, can receive an Internet data request from an end user using a computing device. The CPE device can route the request to a headend system that can include, for example a router and a multi-protocol encapsulation (MPE) device. The headend system can process the request by sending the request to a target process accessible over the Internet for resolution. A response in the form of one or more IP data packets can be received from the process over the Internet in the headend system and the headend system can package the IP packets of the response in one or more MPEG packets. Thereafter, the headend system can forward the MPEG packets to the CPE device through a broadcast TV signal via a broadcast television transmission. Thereafter, the CPE device can process the MPEG packets to extract the IP data packets of the response and can deliver the response to the computing device of the end user. In this way, the broadcast TV signal can be used to transport the response.

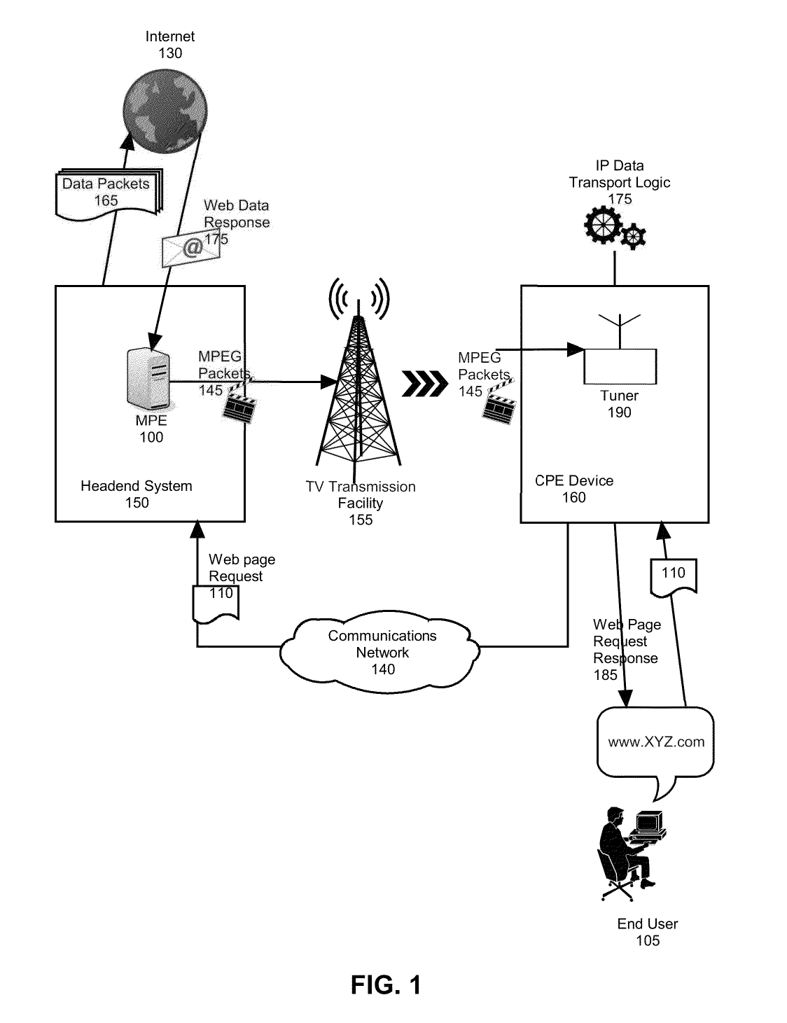

In further illustration, FIG. 1 pictorially shows a process of bi-directional IP data transport to a computing device. As shown in FIG. 1, an end user 105 from a computing device types a uniform resource locator (URL) so a Web page can be displayed on the computing device. The request for the Web page 110 is routed via a communications network 140 by IP data transport logic 175 on a CPE device 160 to a headend system 150. In other words, in one instance, an initial “handshake” can be performed between the CPE device 160 and the headend system 150, so that a communications link is established, enabling the end user 105 initiated request for a desired webpage 110 to be routed from the CPE device 160 to the headend system 150. The communication link can use any transport medium that is capable of transporting IP data packets that is currently known or later developed, including, but not limited to, a local area network (LAN), a virtual private network (VLAN), a wide area network (WAN), a wireless local area network (WLAN), a metropolitan area network (MAN), an Extranet, an Intranet, data over cable service interface specification (DOCSIS) used in cable television, a cellular communications network, a fixed wireless network, a public switch telephone network (PSTN), a broadband communications network, and a digital describer line (DSL). Of note, the specific transport protocol used can be any protocol currently known or later developed, including, but not limited to, transmission control protocol (TCP), user datagram protocol (UDP), eXplicit congestion control protocol (XCP), performance transparency protocol (PTP), grip file transfer protocol (GridFTP), stream control transport protocol (SCTP), protocols that combine aspects of multiple protocols, for instance protocols that combine aspects of both TCP and UDP, and protocols that are based or derived on aspects of a protocol, for instance Reliable Blast UDP (RBUDP), Tsunami, high speed TCP, or scalable TCP. Of note, in some instances, an end user 105 may not need to initiate a request originating at the CPE device 160. For instance, an end user 105 may log onto a website from any computer located anywhere in the world and request, for example, to view a movie video. The website can then retrieve the movie video (the data file) and send the requested data file to the “home” CPE device 160 of the end user 105 via a broadcast TV signal.

Of note, the CPE device 160 can include both a multi-port router (not shown) and a tuner 190. In this way, the router enables the CPE device 160 to sustain a data flow session using concurrent asynchronous routes. In other words, the CPE device 160 can send upstream data via a selected return path from the CPE device 160 to the headend system 150 and receive downstream data via a TV broadcast signal to a tuner 190. Of further note, the CPE device 160 also can include an aggregation of multiple tuners. Of even further note, the CPE device 160 can include executing therein a computer program enabled to provide a variety of functions, including but not limited to full routing, security, firewalling, IP generic route encapsulation, and asynchronous path configuration. Of final note, the headend system 150 can include a router (not shown), Ethernet switch (not shown), and a multi-protocol encapsulation (MPE) device 100. The headend system 150 can further include software capable of providing a variety of functions, including but not limited to routing, security and firewalling, generic route encapsulation, asynchronous path configuration, Virtual Private Networking (VPN) and end user specific header addressing.

Referring to FIG. 1, upon receiving the user initiated request, the headend system 150 adds public internet address information to the user request and forwards the data packets 165 into the Internet 130. A web data response 175 in the form of IP data packets can then be received by the headend system 150 and sent to the MPE device 100. The MPE device 100 can then segment the IP packet responses into MPEG packets 145 for Advanced Television Systems Committee (ATSC) transmission. The MPE device 100 further assigns the associated packet identifier (PID) of the requesting CPE device 160 to the MPEG packets 145. The MPEG packets 145 can then be forwarded to a TV transmission facility 155 for broadcasting. A tuner 190 in the CPE device 160 filters its assigned PID addressed packets from the tuned channel transmission and proceeds to reassemble the IP data packets 185, containing the data necessary to respond to the Web page request 110 of the end user 105. Of note, the tuner 190 can be an ATSC tuner. The IP data packets 185 can then be delivered by the CPE device 160 via a LAN Ethernet port (not shown) to the computing device of the end user 105 for display.

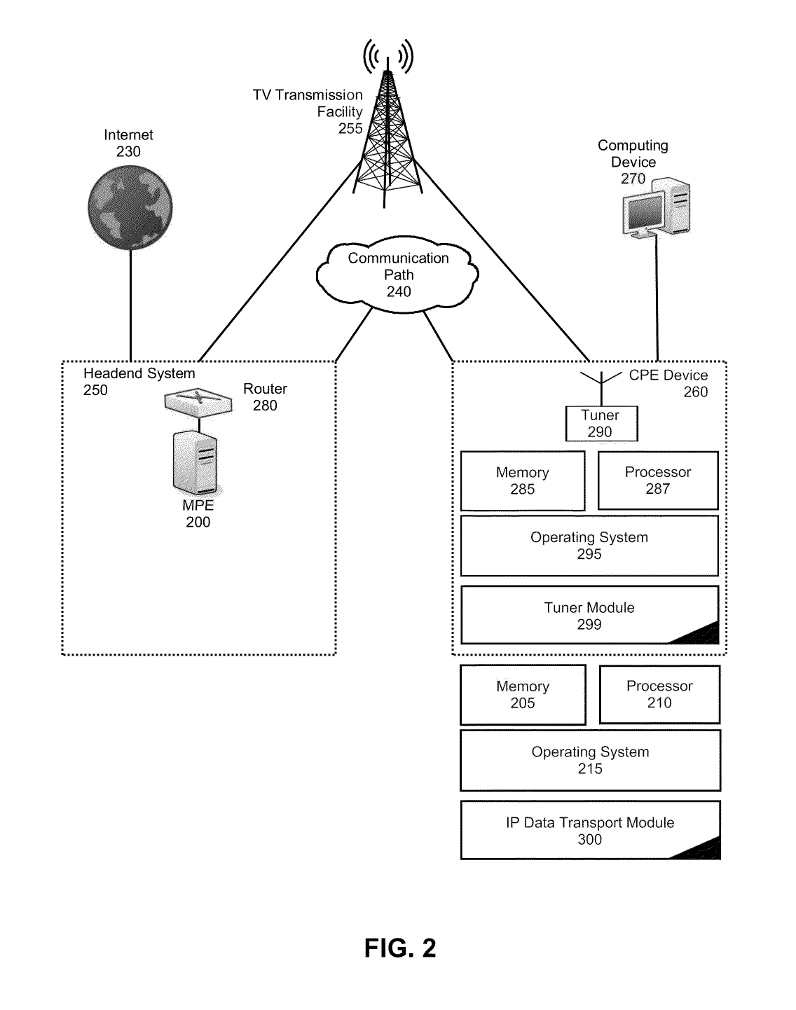

The process described in connection with FIG. 1 can be implemented in a bi-directional IP data transport system. In further illustration, FIG. 2 schematically shows a data processing system configured for bi-directional IP data transport through a digital TV signal. The system can include a CPE device 260. The CPE device 260 can integrate a downstream TV broadcast path, based on ATSC 8VSB format, and an upstream return path to create a single, asymmetric, but concurrently bi-directional IP data communications session. Of note, integrated into the CPE device 260 can be both a tuner 290 as well as a local area network (LAN) Ethernet port. The LAN Ethernet port allows connectivity to a computing device 270 of an end user, and the tuner 290 can listen for and receive downstream traffic from TV signal broadcasted from a TV transmission facility 255. The tuner 290 as well as the LAN Ethernet port can be disposed within the CPE device 260 and coupled to an embedded computer disposed within the CPE device 260. The tuner 290 can include memory 285 and at least one processor 287 disposed within the CPE device 260. Of note, there can be one tuner 290 or multiple tuners, which can be disposed within the CPE device 260 or the tuner 290 can be coupled to the CPE device 260. In other words, the tuner 290 can be disposed within the CPE device 260 or coupled to the embedded computer of the CPE device 260. In this way, the tuner 290 can reside outside of the physical CPE device 260. The tuner 290 can further support the execution of an operating system (O/S) 295 that can in turn support the execution of a tuner module 299. The embedded computer of the CPE device 260 can include at least one processor 210 and memory 205 supporting the execution of an operating system (O/S) 215. The O/S 215 in turn can support the execution of an IP data transport module 300.

The IP data transport module 300 can include program code, which when executed by at least one processor 210 of the embedded computer disposed within the CPE device 260, can establish a communication path between the CPE device 260 and a router 280 of a headend system 250. Of note, more specifically, the embedded computer disposed within the CPE device 260 can be a separate component or can be disposed within another component of the CPE device 260, for instance a router. Of further note, the communication path 240 or upstream communication “tunnel” can be established between the CPE device 260 and the router 280 of the headend system 250 using a variety of return paths (networks) and hardware ports, including but not limited to a local area network (LAN), a virtual private network (VLAN), a wide area network (WAN), a wireless local area network (WLAN), a metropolitan area network (MAN), Extranet, Intranet, data over cable service interface specification (DOCSIS) used in cable television, a Universal Serial Bus (USB), a cellular communications network, a fixed wireless network, a public switch telephone network (PSTN), a broadband communications network, a digital describer line (DSL), a RJ11 phone jack, a LAN Ethernet port, and any other network architecture capable of transmitting and receiving internet protocol (IP) packets with access to the Internet. In this way, upstream data can be sent from the CPE device 260 to the headend system 250 via a return path and receive downstream data via a tuner 290 that was sent through a broadcast TV signal. Of further note, “tunnels” can be established between each CPE device 260 and each router 280 to allow upstream traffic from all CPE devices 260 serviced by a TV transmission facility 255 to be routed out into the Internet 230 via the headend system 250. Of further note, the headend system 250 can be located at a TV transmission facility 255.

Upon configuring the CPE device 260 and selecting a return path through which a communication path 240 is established to the router 280 of the headend system 250, end user upstream data can enter the CPE device 260 from the computing device 270 of the end user through a LAN Ethernet port (not pictured), in one instance, in response to an end user connected to a CPE device 260 initiating a request destined to the Internet 230. In other words, the IP data transport module 300 can include program code enabled to receive an Internet data request from the computing device 270 of an end user. The end user request can be in the form of an end user seeking a website, email, FTP, an Internet search, or other Internet data request. Upon receiving the Internet data request, the IP data transport module 300 can send the upstream data packets to the router 280 of the headend system 250 via the communication path 240. The communication path 240 can utilize a variety of transport mediums of transport networks, for instance TCP or UDP, in order to communicate the Internet data request to the headend system 250.

Of note, the router 280 can be one component of a headend system 250. The router can serve as a gateway to the Internet 230 as well as function as a termination point for the communication path between the CPE device 260 and the headend system 250. Further, the router 280 is used as the source address for requests sent out into the Internet for all requests associated with the computing device 270 coupled to the CPE device 260. Another component of a headend system 250 can be a MPE 200. The MPE 200 can embed IP data packets into MPEG packets as well as insert an address into the MPEG header in the form of a unique PID for transmission over ATSC 8VBS format as used in television broadcasting. Of further note, it should be understood that the headend system 250 can support the execution of a headend module that can include program code to perform and/or instruct the components of the headend system 250 to execute a variety of tasks.

In response to receiving upstream data packets, the router 280 can readdress the upstream data packets as if the router 280 of the headend system 250 is the originating source. The router 280 then can forward the readdressed upstream data packets out into the Internet 230. A reply from the Internet 230 can then be received at the headend system 250. More specifically, the router 280 can map downstream IP data packets to the IP address of the computing device 270 of the end user and can transfer the addressed downstream IP data packets to the MPE 200.

Upon receiving the downstream IP data packets, the MPE 200 can embed the downstream IP data packets into MPEG packets and address the headers of the MPEG packets with a PID, which corresponds to the CPE device 260 of the requesting computing device 270. Of note, the MPE 200 builds ATSC complaint MPEG packets; for instance, the MPE can create MPEG packets that are ATSC 8VBS formatted which can be transmitted using a digital broadcast TV signal. The MPE 200 can then forward addressed MPEG packets to a TV transmission facility 255 for downstream broadcast.

The operating system 215 of the embedded computer of the CPE device 260 can further include program code to instruct the tuner module 299, which can include program code enabled to listen to all broadcasted MPEG packets and to only act upon MPEG packets with a PID address that matches the unique ID of the tuner 290. Upon identifying MPEG packets with the correct PID address, the tuner module 299 can include program code enabled to de-encapsulate the MPEG packets. Specifically, the tuner module 299 can extract downstream IP data packets (de-encapsulation) from the MPEG packet. The tuner module 299 can forward the extracted IP data packets to the embedded computer of the CPE device 260 so the IP data transport module 300 can formulate a response, which can be in the form of a data packet, to the Internet data request according to the extracted downstream IP data packets and route the IP data response (the response data packet, for instance) to the computing device 270 of the end user, via a LAN Ethernet port, for instance, where the computing device 270 can then display the response.

Of note, in some instances, an end user may not need to initiate a request from a computing device 270 connected at the CPE device 260. Instead, in this instance, the module 300 can include program code enabled to allow the CPE device 260 to receive IP data through a broadcast television (TV) signal. In this way, an end user may log onto a website from any computer located anywhere in the world and request, for example, to request a movie video. The website can retrieve the movie video (the data file) and send the data file via a broadcast TV signal to a “home” CPE device 260, where the CPE device 260 would act as a receiver.

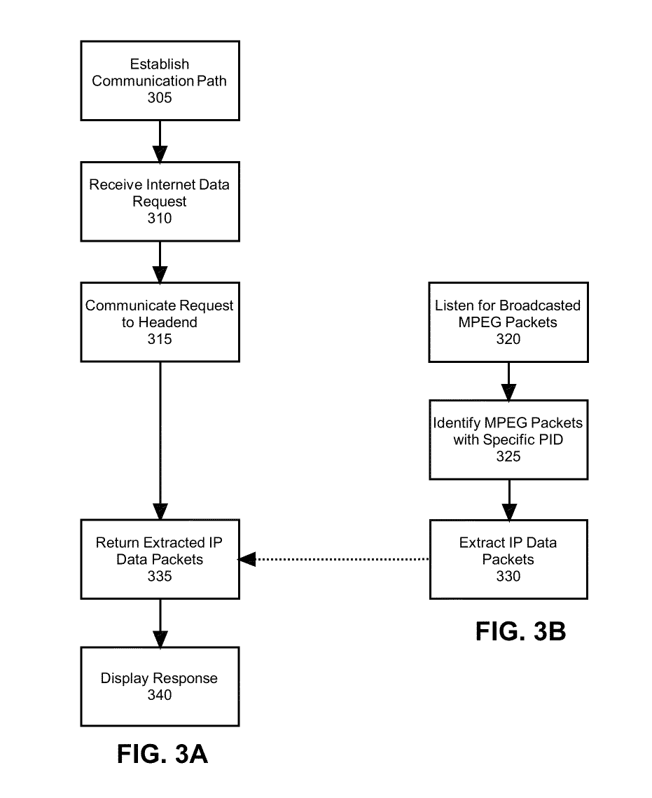

In even yet further illustration of the operation of the program code of the IP data transport module 300 and the tuner module 299, FIG. 3A is a flow chart depicting a process for bi-directional IP data transport and FIG. 3B is a flow chart depicting a process for receiving IP data, respectively. Beginning in step 305, a communication path can be established. The communication path can use a variety of transport mediums of transport networks, including but not limited to TCP and UDP. In step 315, an Internet data request in the form of upstream data packets can be communicated to the headend system over the communication path in response to receiving the Internet data request from a computing device of an end user, as indicated in step 310. The headend system processes the data packets, including but not limited to readdressing the upstream data packets, forwarding the upstream data packets to the Internet in order to receive a reply to the Internet data request, and mapping the downstream data packets to the IP address of the requesting user. The headend system can further transfer the downstream packets to the appropriate headend system component for MPEG packet creation, add the PID into the MPEG packets, and forward the MPEG packets to a TV transmission facility for broadcasting.

As shown in step 320, the broadcasted MPEG packets can be listened for so that the MPEG packets with specific PIDs corresponding to the CPE device that the computing device of the end user is connected to can be identified, as illustrated in step 325. Once identified, the IP data packets can be extracted from the MPEG packets, as shown in step 330. The extracted IP data packets can be forwarded by the tuner module 299 to the IP data transport module 300. In step 335, a response to the Internet data request, for instance a response data packet, containing the extracted IP data packets can be returned to the computing device for display to the end user, as indicated in step 340. Of note, the response can be routed via the LAN Ethernet port to the computing device of the end user.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer, or entirely on the remote computer or server. In the last scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems), and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams and combinations of blocks in the flowchart illustrations and/or block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block(s). The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block(s).

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been offered for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application and to enable others of ordinary skill in the art to understand the invention for various potential embodiments with various potential modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for bi-directional Internet protocol (IP) data transport through a broadcast television (TV) signal, comprising:
establishing a communication path between a customer premise equipment (CPE) device and a router of a headend system;
receiving an Internet data request from a computing device of an end user at the CPE device;
communicating the request to the headend system over the communication path;
listening for motion picture expert group (MPEG) packets broadcasted from a TV transmission facility through the headend system in response to the request;
extracting Internet protocol (IP) data packets from the MPEG packets; and,
returning the extracted IP data packets to the computing device as a response to the Internet data request.

2. The method of claim 1, wherein the communication path is coupled to a return path through which IP data packets flow upstream from the CPE device to the headend system.

3. The method of claim 1, wherein the communication path is a transmission control protocol (TCP) communication path.

4. The method of claim 1, wherein the communication path is a user datagram protocol (UDP) communication path.

5. A bi-directional Internet protocol (IP) data transport system, comprising:
a customer premise equipment (CPE) device;
an embedded computer comprising at least one processor and memory disposed within the CPE device;
a tuner comprising at least one processor and memory coupled to the CPE device and coupled to the embedded computer;
an Internet protocol (IP) data transport module executing in memory of the embedded computer, the IP data transport module comprising program code enabled upon execution in the computer to establish a communication path between the CPE device and a router of a headend system, to receive an Internet data request from a computing device of an end user at the CPE device, to communicate the request to the headend system over the communication path, and to return the IP data packets as a response to the Internet data request to the computing device of the end user; and,
a tuner module executing in memory of the tuner, the tuner module comprising program code enabled to listen for motion picture expert group (MPEG) packets broadcasted from a TV transmission facility through the headend system as a response to the request and to extract IP data packets from the MPEG packets.

6. The system of claim 5, wherein the tuner comprises an aggregation of multiple tuners.

7. The system of claim 5, wherein the communication path is coupled to a return path through which IP data packets flow upstream from the CPE device to the headend system.

8. The system of claim 5, wherein the tuner is an ATSC tuner

9. The system of claim 5, wherein the communication path is a transmission control protocol (TCP) communication path.

10. The system of claim 5, wherein the communication path is a user datagram protocol (UDP) communication path.

11. A computer program product for bi-directional Internet protocol (IP) data transport, the computer program product comprising:
a computer readable storage medium having computer readable program code embodied therewith, the computer readable program code comprising:
computer readable program code for establishing a communication path between a customer premise equipment (CPE) device and a router of a headend system;
computer readable program code for receiving an Internet data request from a computing device of an end user at the CPE device;
computer readable program code for communicating the request to the headend system over the communication path;
computer readable program code for listening for motion picture expert group (MPEG) packets broadcasted from a TV transmission facility through the headend system in response to the request;
computer readable program code for extracting Internet protocol (IP) data packets from the MPEG) packets; and,
computer readable program code for returning the extracted IP data packets to the computing device as a response to the Internet data request.

12. The computer program product of claim 11, wherein the communication path is coupled to a return path through which data packets flow upstream from the CPE device to the headend system.

13. The computer program product of claim 11, wherein the communication path is a transmission control protocol (TCP) communication path.

14. The computer program product of claim 11, wherein the communication path is a user datagram protocol (UDP) communication path.
